(19) United States
(12) Patent Application Publication
(10) Pub. No.: US 2014/0136432 A1
(43) Pub. Date: May 15, 2014

(54) USING SOCIAL NETWORK CONNECTIONS TO RECOMMEND MERCHANTS AND PRODUCTS

(71) Applicant: Thomas Mackenzie Fallows, San Francisco, CA (US)

(72) Inventor: Thomas Mackenzie Fallows, San Francisco, CA (US)

(21) Appl. No.: 13/674,880

(22) Filed: Nov. 12, 2012

(51) Int. Cl. G06Q 99/00

(52) U.S. Cl. 705/319

(57) ABSTRACT

The invention provides a computer-implemented method for using social network connections to recommend merchants and products. The method comprises receiving a set of transaction data from a plurality of transactions, the transaction data comprising an identity of one or more customers and information relating to the experience of the customer with the transaction; categorizing the transaction data; storing the transaction data in a database; receiving a request from a user network device associated with a user, the request comprising the identity of a merchant or a product associated with a website; searching the social graph of the user for instances of the one or more customers; identifying one or more contacts in the social graph of the user that are in the database; and communicating the experiences of the contacts in the social graph of the user that are in the database to the user network device.

### TECHNICAL FIELD

The present disclosure relates generally to merchant recommendations, and more particularly to a method for using social network connections to recommend merchants and products.

### BACKGROUND

The number of merchants available in the online marketplace has grown tremendously. Consumers and other users can search for products to purchase online and can be presented with thousands of merchants offering the products being searched. Many of these merchants are offering products and services at great prices and with attractive options, such as warranties or accessories. Users can search for the lowest priced offer from the many merchants and identify the merchant providing the offer.

Unfortunately, with so many merchants in the online marketplace, it is virtually impossible for a user to be acquainted with every merchant. The user may be hesitant to make a purchase from an unknown merchant despite the attractiveness of the offer. The user may fear that the merchant is fraudulent or unethical. For example, the merchant may sell an inferior or counterfeit product, refuse returns or warranty repairs, ship orders slowly, or in any other way be an unfavorable merchant.

Currently, some search engines, shopping websites, and other entities offer trusted merchant programs. A trusted merchant program can offer to a user a list, approval, badge, or other indication that a merchant is trusted. The merchant can become trusted through a process of the trusted merchant program based on attributes such as customer ratings, shipping times, and other suitable attributes.

While a conventional trusted merchant program may give the user some generic assurance that the merchant is not fraudulent, the conventional trusted merchant program cannot assure a user on a personalized basis that acquaintances or other contacts of the user approve of the merchant. Nor can the conventional trusted merchant give a user specific example of successful purchases completed by friends and family of the user.

### SUMMARY

A computer-implemented method for using social network connections to recommend merchants and products is described. The method comprises receiving, using one or more computer devices, transaction data from a plurality of transactions, the transaction data comprising, for each of the transactions, an identity of a customer and information relating to the experience of the customer with the corresponding transaction; receiving a request from a user computing device associated with a user, the request comprising an identity of a merchant or a product; searching social graph information of the user to identify any instances of at least one customer identified in the transaction data and having a particular transaction that is related to the merchant or the product in the request; extracting each experience corresponding to the identified social graph instances of the at least one customer identified in the transaction data and having a particular transaction that is related to the merchant or the product in the request; and communicating information regarding each extracted experience to the user computing device for presentation on the user computing device.

A computer program product that is installed on a server located in a trusted merchant system for using social network connections to recommend merchants and products also is described. The computer program product includes a non-transitory computer-readable storage device having computer-readable program instructions stored therein. The computer-readable program instructions include computer program instructions for receiving transaction data from a plurality of transactions, the transaction data comprising, for each of the transactions, an identity of a customer and information relating to the experience of the customer with the corresponding transaction; receiving a request from a user computing device associated with a user, the request comprising an identity of a merchant or a product; searching social graph information of the user to identify any instances of at least one customer identified in the transaction data and having a particular transaction that is related to the merchant or the product in the request; extracting each experience corresponding to the identified social graph instances of the at least one customer identified in the transaction data and having a particular transaction that is related to the merchant or the product in the request; and communicating information regarding each extracted experience to the user computing device for presentation on the user computing device.

These and other aspects, objects, features and advantages of the example embodiments will become apparent to those having ordinary skill in the art upon consideration of the following detailed description of illustrated example embodiments, which include the best mode of carrying out the invention as presently presented.

### BRIEF DESCRIPTION OF THE DRAWINGS

FIG. 1 is a block diagram depicting a system for using social network connections to recommend merchants and products, in accordance with certain example embodiments.

FIG. 2 is a block flow diagram depicting a method for using social network connections to recommend merchants and products, in accordance with certain example embodiments.

FIG. 3 is a block flow diagram depicting a method for a merchant system to determine if a merchant is trusted, in accordance with certain example embodiments.

FIG. 4 is a block flow diagram depicting a method for a trusted merchant system to determine if social graph experiences are available, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

The example embodiments described herein provide a trusted merchant system that can employ a user's social graph to recommend merchants and/or products. The social graph of a user refers to all of a user's contacts, friends, family, colleagues, and other members of a user's online network. The social graph not only determines the members of a user's network, but also determines how the members are related and how closely the members are related.

A user can conduct an Internet search for a product or a merchant on a user network device. As used throughout the specification, the term “products” should be interpreted to include tangible and intangible products, as well as services. The search can comprise any type of Internet search. For example, the user can enter a keyword in a search engine for a merchant or a product. On a merchant website, a user can search for a particular product. A user may alternatively follow a link to a merchant or a particular product for sale on the merchant website. Any suitable manner of locating a website for a merchant or a product can be utilized.

After arriving at a merchant site or on a product page on a merchant site, the user device is provided instructions by the website to request a status from the trusted merchant system. The user network device initiates a contact with the trusted merchant system over the network and makes the request.

The trusted merchant system can receive the request from the user device and determine if the merchant is a trusted merchant. The trusted merchant system can additionally or alternatively determine if the product is a trusted product.

Additionally or alternatively, the user can review a list of trusted merchants on a website or other suitable location associated with a trusted merchant system. For example, the trusted merchant system can display a list of all trusted merchants, all trusted merchants in a certain merchant category, all trusted merchants in a certain location, all trusted merchants corresponding to a web search or shopping search, or all trusted merchants in any other suitable configuration. In another example, the user or the user device can request the trusted merchant status while viewing content, an advertisement, or other offer concerning a merchant or a product. The trusted merchant status of a merchant can be requested and/or presented to a user on a user device in any suitable location and at any suitable time.

To determine the status of a merchant, the trusted merchant system determines if the merchant is registered with the trusted merchant system. The merchant can sign up to the program and request a trusted merchant status. The trusted merchant system can obtain merchant data such as product categories, locations, webpage characteristics, shipping programs, customer service data, and other suitable data that will allow the trusted merchant system to characterize the merchant.

Based on the characteristics of the merchant, the trusted merchant system can impose a grading system or other benchmarks for the merchant. Different categories of merchant may have different grading systems for different aspects of the merchants. For example, an aspect of the merchant that the trusted merchant system can log and evaluate is the on-time shipping of product. For a merchant that ships an inexpensive commodity, such as paper goods or pet supplies, a shipping time of more than 3 days can be considered to be a delayed shipment. For a merchant that is shipping a more complex product such as home appliances or laboratory equipment, a shipping time of 14 days can still be considered to be a reasonable shipping time.

The merchant allows the trusted merchant system to log the shipping of products and other aspects of the business, such as reviews by customers, customer service issues, returns, complaints, resolution of complaints, and other suitable aspects. Using the logged data, the trusted merchant system can build a profile of the merchant and compare the profile and features of the profile to a set of standards, thresholds, or other grading systems to determine if the merchant has earned a trusted merchant status.

In alternate embodiments, certain data for a merchant can be logged without the permission of the merchant. For example, solicited surveys, reviews, or other suitable data may be collected about a merchant to further evaluate the merchant. The merchant may further be evaluated in the trusted merchant system without joining the program or requesting an evaluation.

The trusted merchant system can further associate a specific grade to the status of the merchant. For example, the status can be a letter grade such as A, A+, B, or other grade letter. The status can be a descriptive text status such as “Trusted Merchant,” “Superior Merchant,” “Marginal Merchant,” or other suitable text. The status can be a number score such as a 0-100 scoring system. The status can be 5-star, 4-star, 3-star, or other star rating. Any other suitable status system can be utilized.

When the trusted merchant system receives a request from a user device to provide a trusted merchant status, the trusted merchant system assesses the grade of the merchant from the database. The threshold grade of the merchant that is required to be presented to the user as a trusted merchant can be configured by the user, the trusted merchant system, the website, the merchant, or other suitable party. For example, the user can request that only merchants scoring above a threshold grade, such as a B+, should be presented as a trusted merchant. In another example, the merchant can request that only when the grade of the merchant is an A or higher should the grade be presented to a user. Multiple criteria can be used to determine whether to present the trusted merchant assessment to the user.

If the status of the merchant meets or exceeds the grade threshold, then the merchant is identified as a trusted merchant, and the trusted merchant system communicates the trusted merchant status to the user network device for display in connection with the merchant's web page. If the status of the merchant does not meet or exceed the grade threshold, then the merchant is not identified as a trusted merchant.

A process similar to the trusted merchant identification can be conducted to determine if a product is trusted. Based on the performance of the product, reviews, returns, or other characteristics of a product, then a product may be identified as a trusted product. The product and the merchant trusted status can be combined to identify a trusted product being offered by a trusted merchant. The grades or scores of the merchant and the product can be listed separately, combined, averaged, added together, or otherwise presented to the user device.

The user network device requests of the trusted merchant system if one or more members of the social graph of the user have an established experience with the merchant or the product. The trusted merchant system provides the user device with a representation of the experiences of the social graph connections.

The trusted merchant system logs experiences of customers with certain merchants or groups of merchants. The customers can register with the trusted merchant system or can otherwise have the experiences logged. The trusted merchant system can receive experiences of the customer, such as shipping times, returns, customer service response times, reviews, recommendations, or other suitable experience indicators.

The experiences of the customers are categorized by the trusted merchant system and stored in a database on the trusted merchant system. The different characteristics of the experience can be stored in different categories. For example, the time taken for a product to be shipped might be in a shipping database associated with the merchant or product. In another example, a review of a merchant may be quantified, such as by the number of stars awarded by the customer, and stored in a review database associated with the merchant. Other aspects may be stored in appropriate databases.

Upon receipt of a request from a user network device, the trusted merchant system accesses the social graph of the user and searches for social graph connections that are represented in the database. The social graph can be any combination of social networks of the user, contact databases of the user, lists of email correspondents of the user, lists of frequent transaction counter-parties of the user, and any other suitable social graph data. In an alternate example embodiment, other attributes connecting the user to other customers may be employed. For example, the trusted merchant system may search for users sharing a similar location, working in a similar career, or other suitable attributes.

The trusted merchant system identifies members of the social graph of the user that are in the database associated with a merchant or a product. That is, if a person in the social graph of the user has an experience logged at the merchant associated with the request, then the trusted merchant system can identify the experience.

The trusted merchant system further associates a specific grade to the status of the experience. For example, the experience of the customer can be a letter grade such as A, A+, B, or other letter grade. The experience can be a descriptive text status such as “Good Experience,” “Superior Experience,” “Marginal Experience,” or other suitable text. The status can be a number score such as a 0-100 scoring system. Any other suitable experience system can be utilized.

The trusted merchant system associates the experience grade with data from the experience such as number of days to ship, number of returns, time required to respond to an issue, or other data.

When the trusted merchant system receives a request from a user device to provide a social graph contact experience, the trusted merchant system accesses the grade of the experience from the database. The threshold grade of the experience that is required to be presented to the user as a social graph contact experience can be configured by the user, the trusted merchant system, the website, the merchant, or other suitable party. For example, the user can request that only experiences scoring above a threshold grade, such as a B+, should be presented as a recommendation. Alternatively, the user may request presentation of lower scores from their social graph to provide an indication of the experience of other users in the social graph. In another example, the merchant can request that only when the grade of the experience is an A or higher should the grade be presented to a user.

If the status of the experience meets or exceeds the grade threshold, then the experience is identified as a recommendation. If the status of the experience does not meet or exceed the grade threshold, then the experience is not identified as a recommendation.

The trusted merchant system transmits the trusted merchant status and/or the social graph contact experiences to the user device. The status and experience can be displayed to the user as a badge, popup window, banner, or other suitable display. The display can be incorporated as part of the webpage of the merchant or the product or as a separate webpage or other suitable display.

In an example embodiment, the trusted merchant status can be displayed as a badge on the webpage of a merchant. The badge can display the fact that the merchant is a trusted merchant and can additionally display characteristics of the merchant that contribute to the trusted merchant status. For example, the badge can display the percentage of shipments that are on time or shipped within a configured time frame such as within 1 week. The badge can display the number of positive reviews received by the merchant. Any other suitable data can be displayed.

Additionally or alternatively, in the example embodiment, the badge can display the experience of a social graph contact of the user. For example, the badge may display a message, such as “Three of your friends received their orders in three business days.” In another example, the badge may display a message such as “Your friend, Bob Williams, gave this product four stars.” Any suitable summary, statement, rating, grade, or other data of the experience of a social graph contact of the user can be utilized.

The badge may display the trusted merchant status and the experience of a social graph contact of the user in a single display or in multiple displays. The user, the merchant, the trusted merchant system, or any suitable party may configure the displays based on user preferences, the configuration of the website, the data to be presented, or any suitable configuration criteria.

In another example embodiment, the trusted merchant system can use the experience of a social graph contact to adjust the grade of the merchant or product. For example, if a merchant has an A grade, but the experience of multiple social graph contacts is negative, then the trusted merchant system might lower the grade of the merchant. The lowered grade may be below the threshold and thus the badge is not transmitted to the user device. In another example, the trusted merchant system can still display the badge and include the negative experiences of a social graph contacts. In another example, if the merchant grade is poor, but the experiences of multiple social graph contacts is great, then the trusted merchant system may increase the grade of the merchant.

In an example embodiment, the trusted merchant system only displays positive results for the trusted merchant assessment and for the experiences of a social graph contact. That is, only grades over a threshold are displayed and low grades are withheld. In an alternate example, all grades are displayed.

In an example embodiment, the displays can combine the merchant grade and the experiences of a social graph contact for a merchant and a product being offered by the merchant. That is the display can combine, average, add, or in any other suitable manner present the displays for the merchant in combination with the product. For example, the display can present an average score of A− for the merchant and the product and further display that the merchant has three positive reviews from social graph contacts of the users and that the product has one positive review from a social graph contact. Any suitable combination of displays can be utilized.

The functionality of the example embodiments will be explained in more detail in the following description, read in conjunction with the figures illustrating the program flow.

### Example System Architectures

Turning now to the drawings, in which like numerals represent like (but not necessarily identical) elements throughout the figures, example embodiments of the present invention are described in detail.

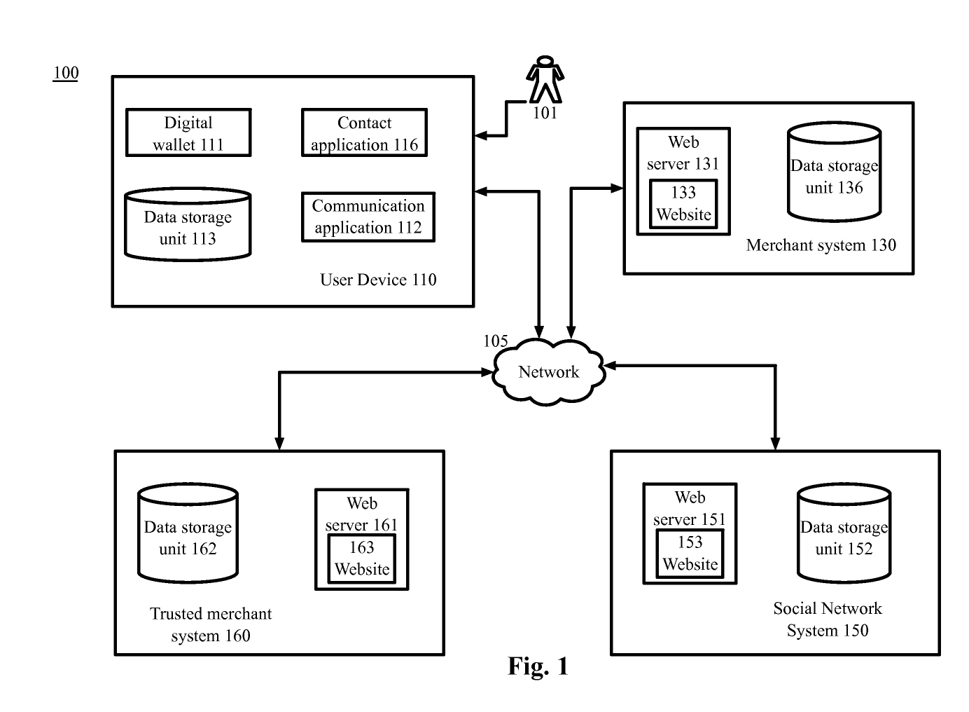

FIG. 1 is a block diagram depicting a system for using social network connections to recommend merchants and products, in accordance with certain example embodiments. As depicted in FIG. 1, the system 100 includes network devices 110, 130, 150, and 160 that are configured to communicate with one another via one or more networks 105.

Each network 105 includes a wired or wireless telecommunication means by which network devices (including devices 110, 130, 150, and 160) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 110, 130, 150, and 160 includes a device having a communication module capable of transmitting and receiving data over the network 105. For example, each network device 110, 130, 150, and 160 can include a server, desktop computer, laptop computer, tablet computer, a television with one or more processors embedded therein and/or coupled thereto, smartphone, handheld computer, personal digital assistant (“PDA”), or any other wired or wireless, processor-driven device. In the example embodiment depicted in FIG. 1, the network devices 110, 130, 150, and 160 are operated by end-users, merchant system operators, social network system operators or users, and trusted merchant system operators, respectively.

The user 101 can use a communication application 112, such as a web browser application or a stand-alone application, to view, download, upload, or otherwise access documents or web pages via a distributed network 105. The network 105 includes a wired or wireless telecommunication system or device by which network devices (including devices 110, 130, 150, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The communication application 112 can interact with web servers or other computing devices connected to the network 105, including the web server 161 of the trusted merchant system 160, the web server 131 of the merchant system 130, and the web server 151 of the social network system 150. The communication application 112 can further communicate with a terminal reader and/or the point of sale terminal (not shown) of the merchant system 130 via any contactless communication technology such as NFC, BLUETOOTH, Wi-Fi, infrared, or other suitable technology.

The user network device 110 may include a digital wallet application module 111. The digital wallet application module 111 may encompass any application, hardware, software, or process the user device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112.

The user device 110 also includes a data storage unit 113 accessible by the digital wallet application module 111, the stored value application 115, and the communication application 112. The example data storage unit 113 can include one or more tangible computer-readable storage devices. The data storage unit 113 can be stored on the user device 110 or can be logically coupled to the user device 110. For example, the data storage unit 113 can include on-board flash memory and/or one or more removable memory cards or removable flash memory.

The user device 110 may include one or more contact applications 116. A contact application 116 may be any program or application on the user device 110 or accessible by the user device 110 that maintains a list of contacts of the user that the trusted merchant system 160 may access. Examples of contact applications 116 might include, but not be limited to, email applications, text applications, instant messaging, calendar invite lists, or contact databases such as OUTLOOK or ACT. The contacts from a contact application 116 may be prioritized by factors such as frequency of communication with user 101, the number of contact applications on which a particular contact appears, or any other prioritizing factors which may be extracted from the applications.

The user 101 can use a web server 161 on the trusted merchant system 160 to view, register, download, upload, or otherwise access the trusted merchant system 160 via a website 163 and a communication network 105. The user's 101 registration information is saved in the trusted merchant system's data storage unit 162 and is accessible the by web server 161. From the trusted merchant system 160, the user 101 can access the trusted merchant status of a merchant system 130 and recommendations of friends of the user 101.

The trusted merchant system 160 includes a data storage unit 162 accessible by the web server 161. The example data storage unit 162 can include one or more tangible computer-readable storage devices.

The merchant system 130 may use a web server 131 to view, download, upload, create offers, sell products online, or otherwise access the stored value system 160 via a website 133 and a communication network 105. The web server 131 may be part of the merchant system 130 and located at the merchant system 130 location. The web server 131 may alternatively be located at a remote location. The merchant system 130 represents an entity that offers products for the user 101 to purchase or use. The merchant system 130 may be embodied as a physical merchant at a physical location or an online merchant.

The social network system 150 utilizes a social network system server 151. The social network server 151 may represent the computer-implemented system that the social network system 150 employs to host the social network website 153 and all of the profiles and communities that use the social network website 153. The social network website 153 may represent any web-based community that allows users to interact over the Internet with others who typically share a common interest. Examples of the social network websites 153 that the user 101 may belong to or interact with may include, but would not be limited to, FACEBOOK, GOOGLE+, or LINKEDIN.

The social network system 150 may provide the trusted merchant system 160 with a list of members of the user's online community. The social network system 150 may identify friends and contacts that can be used to recommend a merchant system 130 and establish the strength the connection with the user 101. The strength of the connection can be determined by factors that may apply to the structure of each particular social network system 150. For example, a social network system 150 such as FACEBOOK may categorize members of the community as “friends” or “friends of friends” and LINKEDIN may categorize members as first, second, or third degree contacts.

The social network system server 151 can communicate with a trusted merchant system 160 and user devices 110 via any available technologies. These technologies may include, but would not be limited to, an Internet connection via the network 105, email, text, instant messaging, or other suitable communication technologies. The social network system 150 may include a data storage unit 152 accessible by the server 151 of the social network system 150. The data storage unit 152 can include one or more tangible computer-readable storage devices.

It will be appreciated that the network connections shown are exemplary and other means of establishing a communications link between the computers and devices can be used. Moreover, those having ordinary skill in the art having the benefit of the present disclosure will appreciate that the user device 110, merchant system 130, social network system 150, and trusted merchant system 160 illustrated in FIG. 1 can have any of several other suitable computer system configurations. For example, a user device 110 embodied as a mobile phone or handheld computer may not include all the components described above.

### Example Processes

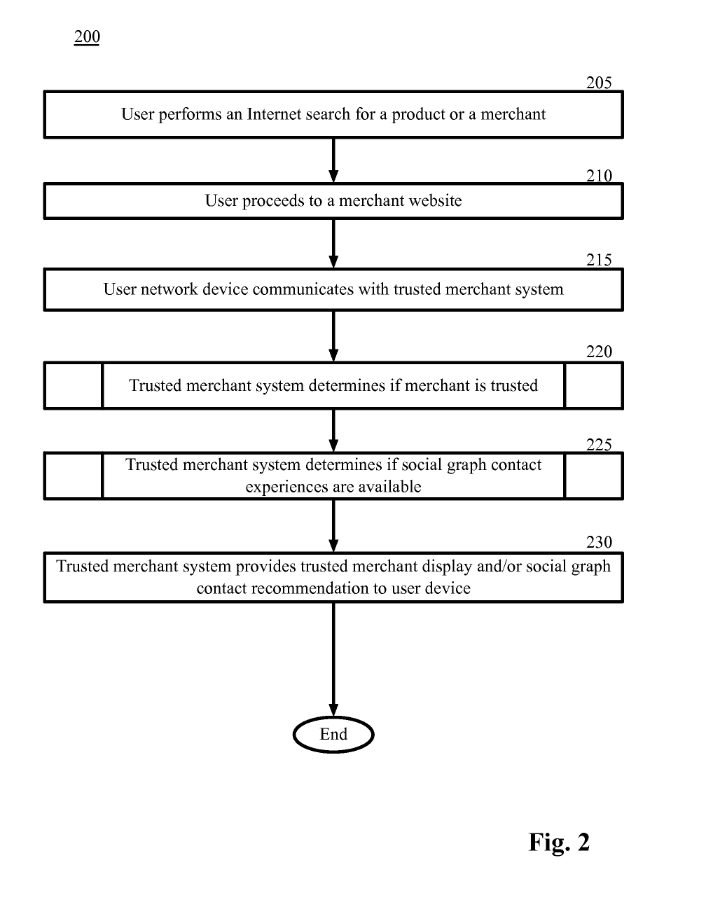

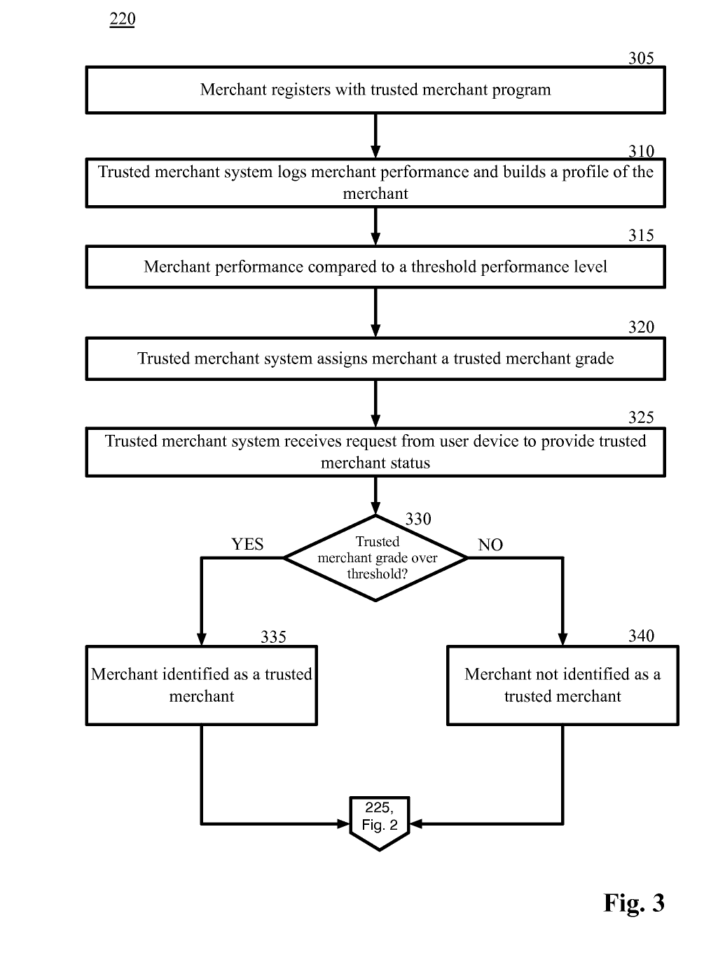

The components of the example operating environment 100 are described hereinafter with reference to the example methods illustrated in FIGS. 2 and 3.

FIG. 2 is a block flow diagram depicting a method 200 for using social network connections to recommend merchants and products, in accordance with certain example embodiments.

With reference to FIGS. 1 and 2, in block 205, a user 101 can conduct an Internet search for a product or a merchant system 130 on a user network device 110. As used throughout the specification, the term “products” should be interpreted to include tangible and intangible products, as well as services. The search can comprise any type of Internet search. For example, the user 101 can enter a keyword in a search engine for a merchant system 130 or a product. On a merchant website 133, a user 101 can search for a particular product. A user 101 may alternatively follow a link to a merchant system 130 or a particular product for sale on the merchant website 133. Any suitable manner of locating a website 133 for a merchant or a product can be utilized.

In block 210, the user 101 proceeds to a merchant website 133 by following a link, advertisement, or other suitable process to arrive at merchant website 133. After arriving at a merchant website 133 or on a product page on a merchant website 133, the user device 110 is provided instructions by the website 133 to request a status from the trusted merchant system 160.

Additionally or alternatively, the user 101 can review a list of trusted merchants on a website or other suitable location associated with a trusted merchant system 160. For example, the trusted merchant system 160 can display a list of all trusted merchants, all trusted merchants in a certain merchant category, all trusted merchants in a certain location, all trusted merchants corresponding to a web search or shopping search, or all trusted merchants in any other suitable configuration. In another example, the user 101 or the user device 110 can request the trusted merchant status while viewing an advertisement or other offer from merchant system 130 or for a product. The trusted merchant status of a merchant 130 can be requested and/or presented to a user 101 on a user device 110 in any suitable location and at any suitable time.

In block 215, the user network device 110 initiates a contact with the trusted merchant system 160 over the network 105 and makes the request. The request can be transmitted by any available communication method, such as an Internet connection over the network 105, email, text, instant message, or any other suitable communication method.

In block 220, the trusted merchant system 160 receives the request from the user device 110 and determines if the merchant system 130 is a trusted merchant. The trusted merchant system 160 can additionally or alternatively determine if the product is a trusted product. The details of block 220 are described in greater detail in the method 220 in FIG. 3.

Turning now to the method 220 in FIG. 3, in block 305, a merchant system 130 signs up to the program and requests a trusted merchant status. The merchant system 130 can register online, via email, in person, or via any other suitable manner.

In alternate embodiments, certain data for a merchant system 130 can be logged without the permission of the merchant system 130. For example, solicited surveys, reviews, or other suitable data may be collected about a merchant system 130 to further evaluate the merchant system 130. The merchant system 130 may further be evaluated in the trusted merchant system 160 without joining the program or requesting an evaluation.

In block 310, the trusted merchant system 160 obtains merchant data such as product categories, locations, webpage characteristics, shipping programs, customer service data, and other suitable data that will allow the trusted merchant system 160 to characterize the merchant. The trusted merchant system 160 can gather historical data from the merchant system 130 and monitor future merchant operations for assessment.

In block 315, based on the characteristics of the merchant, the trusted merchant system 160 compares the performance of the merchant system 130 to a threshold performance level and imposes a grading system or other benchmark for the merchant system 130. Different categories of merchant system 130 may have different grading systems. For example, one aspect of the merchant system 130 that the trusted merchant system 160 can log and evaluate is the on time shipping of product. For a merchant system 130 that ships an inexpensive commodity, such as paper goods or pet supplies, a shipping time of more than 3 days can be considered to be a delayed shipment. For a merchant system 130 that is shipping a more complex product such as home appliances or laboratory equipment, a shipping time of 14 days can still be considered to be a reasonable shipping time.

The merchant system 130 can allow the trusted merchant system 160 to log the shipping of products and other aspects of the business such as reviews by customers, customer service issues, returns, complaints, resolution of complaints, and other suitable aspects.

In block 320, the trusted merchant system 160 assigns a trusted merchant grade to the merchant system 130. Using the logged data, the trusted merchant system 160 can build a profile of the merchant system 130 and compare the profile and features of the profile to a set of standards, thresholds, or other grading systems to determine if the merchant system 130 has earned a trusted merchant status.

The trusted merchant system 160 can associate a specific grade to the status of the merchant system 130. For example, the status can be a letter grade such as A, A+, B, or other letter grade. The status can be a descriptive text status such as “Trusted Merchant”, “Superior Merchant”, “Marginal Merchant”, or other suitable text. The status can be a number score such as a 0-100 scoring system. Any other suitable status system can be utilized.

In block 325, the trusted merchant system 160 receives a request from a user device 110 or other device to provide a trusted merchant status. When the trusted merchant system 160 receives a request from a user device 110 to provide a trusted merchant status, the trusted merchant system 160 can assess the grade of the merchant from the database.

In block 330, the trusted merchant system 160 determines if the trusted merchant grade is over a threshold. The threshold grade of a merchant system 130 that is required to be presented to the user 101 as a trusted merchant can be configured by the user 101, the trusted merchant system 160, the website, the merchant, or other suitable party. For example, the user 101 can request that only merchants scoring above a threshold grade, such as a B+, should be presented as a trusted merchant. In another example, the merchant system 130 can request that only when the grade of the merchant system 130 is an A or higher should the grade be presented to a user 101.

If the status of the merchant system 130 meets or exceeds the grade threshold, then the method 215 follows the “YES” branch of block 330 to block 335. If the status of the merchant system 130 does not meet or exceed the grade threshold, then the method 215 follows the “NO” branch of block 330 to block 340.

Following the YES branch of block 330 to block 335, the merchant system 130 is identified as a trusted merchant. Following the NO branch of block 330 to block 340, the status of the merchant system 130, the merchant system 130 is not identified as a trusted merchant. The trusted merchant status of the merchant system 130 can be logged on the trusted merchant system 160 in a merchant account, on a database, or on any other logging system.

A process similar to the trusted merchant identification can be conducted to determine if a product is trusted. Based on the performance of the product, reviews, returns, or other characteristics of a product, then a product may be identified as a trusted product. The trusted merchant status can be combined to identify a trusted product being offered by a trusted merchant. The grades or scores of the merchant system 130 and the product can be listed separately, combined, averaged, added together, or otherwise presented to the user device 110.

From block 330 and block 335, the method 215 returns to block 220 of FIG. 2.

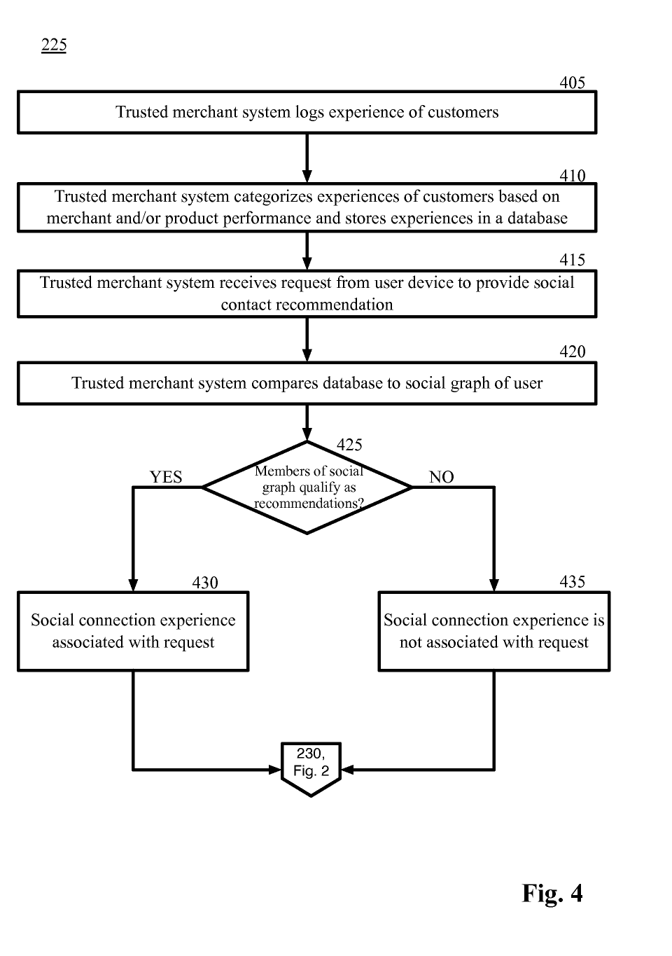

Returning to FIG. 2, in block 225, the trusted merchant system determines if contacts from the social graph of the user 101 have experiences with the merchant system 130 or the product. The details of block 225 are described in greater detail in the method 225 in FIG. 4.

Turning now to the method 225 in FIG. 4, in block 405, the trusted merchant system 160 logs experiences of customers with certain merchant systems 130 or groups of merchants. The customers can register with the trusted merchant system 160 or can otherwise have the experiences logged. The trusted merchant system 160 can receive experiences of the customer such as shipping times, returns, customer service response times, reviews, recommendations, or other suitable experience indicators.

In block 410, the experiences of the customers are categorized by the trusted merchant system 160 and stored in a database on the trusted merchant system 160. The different characteristics of the experience can be stored in different categories. For example, the time taken for a product to be shipped might be in a shipping database associated with the merchant system 130 or product. In another example, a review of a merchant system 130 may be quantified, such as by the number of stars awarded by the customer, and stored in a review database associated with the merchant system 130. Other aspects may be stored in appropriate databases.

In block 415, the trusted merchant system 160 receives a request from a user device to provide social contact recommendations. Upon receipt of a request and permission from the user 101, the trusted merchant system 160 can access the social graph of the user 101 and search for social graph connections that are represented in the database. The social graph can be any combination of social networks of the user 101, contact databases of the user 101, lists of email correspondents of the user 101, lists of frequent transaction counter-parties of the user 101, and any other suitable social graph data. The trusted merchant system 160 can request a list of social graph networks and data from the user 101 and request access from the user 101 to the social graph. The user 101 may provide permission or authorization, or in any other suitable manner allow the trusted merchant system 160 access to the social graph data. Alternatively, the permission may be given explicitly at any point in the relationship of the user 101 and the trusted merchant system 160. For example, the permission may be requested and given when the user 101 joins a shopping website, registers an email account, opens a financial account, or performs any action with a system associated with the trusted merchant system 160.

The one or more social network website 153 that the user 101 employs can be any web-based community that allows users to interact over the Internet with others who typically share a common interest. Examples of the social network websites 153 that the user 101 may belong to or interact with may include, but would not be limited to, FACEBOOK, GOOGLE+, or LINKEDIN.

The social network system 150 can provide the trusted merchant system 160 with a list of members of the user's online community. The social network system 150 can identify friends and contacts that can be used to recommend a merchant system 130 and establish the strength the connection with the user 101. The strength of the connection can be determined by factors that may apply to the structure of each particular social network system 150. For example, a social network system 150 such as FACEBOOK may categorize members of the community as “friends” or “friends of friends” and LINKEDIN may categorize members as first, second, or third degree contacts.

A contact application 116 in the social graph of the user 101 can be any program or application on the user device 110 or accessible by the user device 110 that maintains a list of contacts of the user that the trusted merchant system 160 may access. Examples of contact applications 116 might include, but not be limited to, email applications, text applications, instant messaging, calendar invite lists, or contact databases such as OUTLOOK or ACT. The contacts from a contact application 116 may be prioritized by factors such as frequency of communication with user 101, the number of contact applications on which a particular contact appears, or any other prioritizing factors which may be extracted from the applications.

In block 420, the trusted merchant system 160 can identify members of the social graph of the user 101 that are in the database associated with a merchant system 130 or a product. That is, if a person in the social graph of the user 101 has an experience logged at the merchant system 130 associated with the request, then the trusted merchant system 160 can identify the experience.

The trusted merchant system 160 can further associate a specific grade to the status of the experience. For example, the experience of the customer can be a letter grade such as A, A+, B, or other letter grade. The experience can be a descriptive text status such as “Good Experience”, “Superior Experience”, “Marginal Experience”, or other suitable text. The status can be a number score such as a 0-100 scoring system. Any other suitable experience system can be utilized.

The trusted merchant system 160 can associate the experience grade with data from the experience such as number of days to ship, number of returns, time required to respond to a customer service issue, or other data.

In block 425, the trusted merchant system 160 determines if one or more of the experiences of the members of the social graph of the user 101 meet the qualifications to be recommendations. When the trusted merchant system 160 receives a request from a user device 110 to provide a social graph contact experience, the trusted merchant system 160 can access the grade of the experience from the database. The threshold grade of the experience that is required to be presented to the user 101 as a social graph contact experience can be configured by the user 101, the trusted merchant system 160, the website, the merchant system 130, or other suitable party. For example, the user 101 can request that only experiences scoring above a threshold grade, such as a B+, should be presented as a recommendation. In another example, the merchant system 130 can request that only when the grade of the experience is an A or higher should the grade be presented to a user 101.

If the status of one or more of the experiences meets or exceeds the grade threshold, then the method 225 follows the “YES” branch of block 425 to block 430. If the status of one or more of the experience does not meet or exceed the grade threshold, then the method 225 follows the “NO” branch of block 425 to block 435.

Following the YES branch to block 435, the one or more experiences of the social connection are identified as recommendations.

Following the NO branch to block 430, the one or more experiences of the social connection are not identified as recommendations.

From block 430 and block 435, the method 225 returns to block 230 of FIG. 2.

Returning to FIG. 2, in block 230, the trusted merchant system 160 transmits the trusted merchant status and/or the social graph contact experiences to the user device 110. The status and experience can be displayed to the user 101 as a badge, popup window, banner, or other suitable display. The display can be incorporated as part of the webpage 133 of the merchant system 130 or the product or as a separate webpage or other suitable display.

In an example embodiment, the trusted merchant status can be displayed as a badge on the webpage 133 of a merchant system 130. The badge can display the fact that the merchant system 130 is a trusted merchant and can additionally display characteristics of the merchant system 130 that contribute to the trusted merchant status. For example, the badge can display the percentage of shipments that are on time or shipped within a configured time frame, such as within 1 week. The badge can display the number of positive reviews received by the merchant system 130. Any other suitable data can be displayed.

Additionally or alternative, in the example embodiment, the badge can display the experience of a social graph contact of the user 101. For example, the badge may display a message such as “Three of your friends received their orders in three business days.” In another example, the badge may display a message such as “Your friend, Bob Williams, gave this product four stars.” Any suitable summary, statement, rating, grade, or other data of the experience of a social graph contact of the user 101 can be utilized.

The badge may display the trusted merchant status and the experience of a social graph contact of the user 101 in a single display or in multiple displays. The user 101, the merchant system 130, the trusted merchant system 160, or any suitable party may configure the displays based on user 101 preferences, the configuration of the website 133, the data to be presented, or any suitable configuration criteria.

In another example embodiment, the trusted merchant system 160 can use the experience of a social graph contact to adjust the grade of the merchant system 130 or product. For example, if a merchant system 130 has an A grade, but the experience of multiple social graph contacts is negative, then the trusted merchant system 160 might lower the grade of the merchant system 130. The lowered grade may be below the threshold and thus the badge is not transmitted to the user device 110. In another example, the trusted merchant system 160 can still display the badge and include the negative experiences of a social graph contacts. In another example, if the merchant system 130 grade is poor, but the experiences of multiple social graph contacts is great, then the trusted merchant system 160 can increase the grade of the merchant system 130.

In an example embodiment, the trusted merchant system 160 only displays positive results for the trusted merchant assessment and for the experiences of a social graph contact. That is, only grades over a threshold are displayed and low grades are withheld. In an alternate example, all grades are displayed.

In an example embodiment, the displays can combine the grade of the merchant system 130 and the experiences of a social graph contact for a merchant system 130 and a product being offered by the merchant system 130. That is the display can combine, average, add, or any in any other suitable manner present the displays for the merchant system 130 in combination with the product. For example, the display can present an average score of A− for the merchant system 130 and the product and further display that the merchant system 130 has three positive reviews from social graph contacts of the users and the product has one positive review from a social graph contact. Any suitable combination of displays can be utilized.

From block 230, the method 200 ends.

### Other Example Embodiments

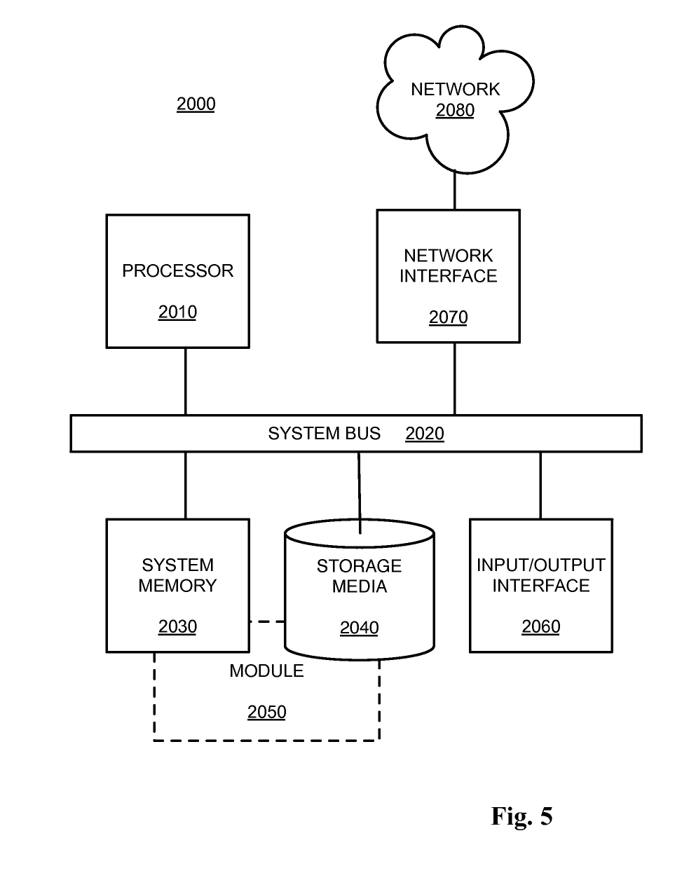

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to display social graph contact recommendations, comprising:
receiving, using one or more computing devices, transaction data from a plurality of transactions, the transaction data comprising, for each of the transactions, an identity of a customer and information relating to an experience of the customer with the corresponding transaction;
receiving, using the one or more computing devices, a request from a user computing device associated with a user, the request comprising an identity of a merchant or a product;
searching, using the one or more computing devices, social graph information of the user to identify any instances of at least one customer identified in the transaction data, each identified customer having engaged in a particular transaction related to the merchant or the product in the request and having a corresponding experience;
extracting, using the one or more computing devices, each corresponding experience; and
communicating, using the one or more computing devices, information regarding each extracted experience to the user computing device for presentation on the user computing device.

2. The computer-implemented method of claim 1, further comprising:
determining, using the one or more computing devices, a grade for one or more of the extracted experiences of the at least one customer from the user's social graph that is identified in the transaction data and having a particular transaction that is related to the merchant or the product in the request;
establishing, using the one or more computing devices, a threshold grade for the one or more extracted experiences; and
comparing, using the one or more computing devices, the determined grade to the to the threshold grade,
wherein the communicating step comprises communicating only extracted experiences having a determined grade that meets or exceeds the threshold.

3. The computer-implemented method of claim 1, wherein the communicating step further comprises communicating a trusted merchant status of the merchant or the product to the user computing device for presentation on the user computing device with the information regarding each extracted experience.

4. The computer-implemented method of claim 1, wherein an identity of each customer in the communicated information is included in the communicated information.

5. The computer-implemented method of claim 1, wherein the experience of the customer with the corresponding transaction comprises one or more of a review of the merchant or product, a shipping time of the product from the merchant, and product return information.

6. The computer-implemented method of claim 1, wherein the transaction data further comprises one or more of product identification, merchant identification, shipping information, and purchase price.

7. The computer-implemented method of claim 1, further comprising:
categorizing, using the one or more computing devices, the transaction data; and
storing, using the one or more computing devices, the transaction data.

8. A computer program product, comprising:
a non-transitory computer-readable storage device having computer-executable program instructions embodied thereon that when executed by a computer displays social graph contact recommendations, the computer-executable program instructions comprising:
computer-executable program instructions for storing transaction data from a plurality of transactions, the transaction data comprising, for each of the transactions, an identity of a customer and information relating to an experience of the customer with the corresponding transaction;
computer-executable program instructions for receiving a request from a user computing device associated with a user, the request comprising an identity of a merchant or a product;
computer-executable program instructions for searching social graph information of the user to identify any instances of at least one customer identified in the transaction data, each identified customer having engaged in a particular transaction related to the merchant or the product in the request and having a corresponding experience;
computer-executable program instructions for extracting each corresponding experience; and
computer-executable program instructions for communicating information regarding each extracted experience to the user computing device for presentation on the user computing device.

9. The computer program product of claim 8, further comprising:
computer-executable program instructions for determining a grade for one or more of the extracted experiences of the at least one customer from the user's social graph that is identified in the transaction data and having a particular transaction that is related to the merchant or the product in the request; and
computer-executable program instructions for comparing, the determined grade to the to the threshold grade,
wherein the communicating step comprises communicating only extracted experiences having a determined grade that meets or exceeds the threshold.

10. The computer program product of claim 8, wherein the communicating step further comprises communicating a trusted merchant status of the merchant or the product to the user computing device for presentation on the user computing device with the information regarding each extracted experience.

11. The computer program product of claim 8, wherein an identity of each customer in the communicated information is included in the communicated information.

12. The computer program product of claim 8, wherein the experience of the customer with the corresponding transaction comprises one or more of a review of the merchant or product, a shipping time of the product from the merchant, and product return information.

13. The computer program product of claim 8, wherein the transaction data further comprises one or more of product identification, merchant identification, shipping information, and purchase price.

14. The computer program product of claim 8, further comprising:
computer-executable program instructions for categorizing the transaction data; and
computer-executable program instructions for storing the transaction data.

15. A system to display social graph contact recommendations, the system comprising:
a storage resource;
a network module; and
a processor communicatively coupled to the storage resource and the network module, wherein the processor executes application code instructions that are stored in the storage resource and that cause the system to:
receive transaction data from a plurality of transactions, the transaction data comprising, for each of the transactions, an identity of a customer and information relating to an experience of the customer with the corresponding transaction;
receive a request from a user computing device associated with a user, the request comprising an identity of a merchant or a product;
search social graph information of the user to identify any instances of at least one customer identified in the transaction data, each identified customer having engaged in a particular transaction related to the merchant or the product in the request and having a corresponding experience;
extract each corresponding experience; and
communicate information regarding each extracted experience to the user computing device for presentation on the user computing device.

16. The system of claim 15, the instructions further causing the system to:
determine a grade for one or more of the extracted experiences of the at least one customer from the user's social graph that is identified in the transaction data and having a particular transaction that is related to the merchant or the product in the request;
establish a threshold grade for the one or more extracted experiences; and
compare the determined grade to the to the threshold grade,
wherein the communicating step comprises communicating only extracted experiences having a determined grade that meets or exceeds the threshold.

17. The system of claim 15, wherein the communicating step further comprises communicating a trusted merchant status of the merchant or the product to the user computing device for presentation on the user computing device with the information regarding each extracted experience.

18. The system of claim 15, wherein an identity of each customer in the communicated information is included in the communicated information.

19. The system of claim 15, wherein the experience of the customer with the corresponding transaction comprises one or more of a review of the merchant or product, a shipping time of the product from the merchant, and product return information.

20. The system of claim 15, wherein the transaction data further comprises one or more of product identification, merchant identification, shipping information, and purchase price.
